(19) United States
(12) Patent Application Publication
(10) Pub. No.: US 2025/0316058 A1
(43) Pub. Date: Oct. 9, 2025

(54) Systems, Methods, and Apparatuses for Hierarchical Embeddings with Localizability, Composability and Decomposability Learned from Anatomy

(71) Applicant: Arizona Board of Regents on behalf of Arizona State University, Scottsdale, AZ (US)

(72) Inventors: Mohammad Reza HOSSEINZADEH TAHER, Tempe, AZ (US); Jianming LIANG, Scottsdale, AZ (US)

(73) Assignee: Arizona Board of Regents on behalf of Arizona State University, Scottsdale, AZ (US)

(21) Appl. No.: 19/064,520

(22) Filed: Feb. 26, 2025

Related U.S. Application Data
(60) Provisional application No. 63/559,799, filed on Feb. 29, 2024.

(51) Int. Cl. G06V 10/762; G06V 10/74; G06V 10/77; G06V 10/774; G06V 10/82

(52) U.S. Cl. CPC G06V 10/7625; G06V 10/761; G06V 10/7715; G06V 10/774; G06V 10/82; G06V 2201/03

(57) ABSTRACT

A system having at least a processor and a memory therein executes instructions for a self-supervised learning framework to learn visual representations of medical images of semantically similar anatomical structures of a plurality of patients. The instructions when executed learn via a localizability branch of the framework a semantically structured embedding space by discriminating between different anatomical structures, learn via a composability branch of the framework part-whole hierarchical relationships of the anatomical structures by constructing each anatomical structure through an integration of parts, and learn via a decomposability branch of the framework whole-part hierarchical relationships of the anatomical structures by decomposing each anatomical structure into its parts.

### CLAIM OF PRIORITY

This application claims the benefit of U.S. Provisional Patent Application No. 63/559,799, filed Feb. 29, 2024, entitled “SYSTEMS, METHODS, AND APPARATUSES FOR HIERARCHICAL EMBEDDINGS WITH LOCALIZABILITY, COMPOSABILITY AND DECOMPOSABILITY LEARNED FROM ANATOMY”, the disclosure of which is incorporated by reference herein in its entirety.

### GOVERNMENT RIGHTS AND GOVERNMENT AGENCY SUPPORT NOTICE

This invention was made with government support under R01 HL128785 awarded by the National Institutes of Health. The government has certain rights in the invention.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments of the invention relate to a self-supervised machine learning strategy that constructs a hierarchy of embeddings for distinct anatomical structures from medical images.

### BACKGROUND

Human perception effortlessly parses visual scenes into part-whole hierarchies. For instance, when interpreting a chest radiograph, even untrained observers can quickly form a hierarchy by dividing the lower respiratory tract into the left and right lungs, whereas more experienced observers can invoke further sub-hierarchies. Deep learning has enabled breakthroughs in learning visual representation at multiple levels. However, the multi-level feature space learned by deep models does not explicitly code part-whole hierarchies with necessary semantic information to indicate hierarchical relationships among wholes and their constituent parts.

To mimic the human ability to understand part-whole hierarchies in images, an imaginary system (i.e., GLOM) has been introduced that aims to signify the importance of explicitly presenting part-whole hierarchies in a neural network. Inspired by the conceptual idea underlying GLOM, the disclosed embodiments provide a self-supervised learning (SSL) framework, leading to a functioning system that, from medical images, autodidactically constructs a hierarchy of embeddings for distinct anatomical structures, semantically balancing anatomical diversity and harmony at each level and conveying parental “whole” at the higher level and filial “parts” at the lower level.

### BRIEF DESCRIPTION OF THE DRAWINGS

Embodiments are illustrated by way of example, and not by way of limitation, and can be more fully understood with reference to the following detailed description when considered in connection with the figures in which:

FIGS. 1A and 1B illustrate how human vision easily organizes images into a tree-like structure, understanding the hierarchical relationships between objects and their parts.

FIG. 2 illustrates embodiments of the invention.

FIG. 3 depicts embodiments of the invention learning localizability of anatomical structures and providing discriminative features for different landmarks.

FIG. 4 depicts embodiments of the invention balancing diversity and harmony in embeddings of similar anatomical structures across patients and resolutions.

FIG. 5 depicts embodiments of the invention capturing part-whole relations of anatomical structures in its embeddings space.

FIG. 6 demonstrates two emergent properties: interpolation and extrapolation, in which the similarity is computed between the interpolated/extrapolated embeddings (E′_{C}/E′_{D}) and their corresponding ground truth (E_{C}/E_{D}), in accordance with embodiments of the invention.

FIG. 7 graphically illustrates that the disclosed embodiments provide generalizable and robust representations that outperform prior art self-supervised methods across diverse down-stream tasks.

FIG. 8 graphically illustrates ablation on the impact of (a) different branches of Adam-V2 (top-row) and (b) coarse-to-fine learning (bottom-row), according to the disclosed embodiments.

FIG. 9 presents Table 1 which shows the disclosed embodiments excelling in few-shot transfer, outperforming large-scale medical models and SSL baselines across segmentation tasks.

FIG. 10 presents Table 2 which shows Adam-V2 outperforms previous methods on the public ChestX-ray 14 benchmark, according to the disclosed embodiments.

FIG. 11 presents Table 3 which shows that Adam-V2, according to the disclosed embodiments, exhibits superior performance across tasks in both settings compared with SSL baselines that leverage the same pretraining data as Adam-V2.

### DETAILED DESCRIPTION

Embodiments of the invention provide for a new self-supervised learning framework, referred to herein as Adam-V2, that encodes inherent hierarchical relationships within medical images, yielding discriminative representations blended with semantics of part-whole relations.

Humans effortlessly interpret images by parsing them into part-whole hierarchies; deep learning excels in learning multi-level feature spaces, but they often lack explicit coding of part-whole relations, a prominent property of medical imaging. To overcome this limitation, the disclosed embodiments introduce Adam-V2, a new self-supervised learning framework explicitly incorporating part-whole hierarchies into its learning objectives through three key branches: (1) Localizability, acquiring discriminative representations to distinguish different anatomical patterns; (2) Composability, learning each anatomical structure in a parts-to-whole manner; and (3) Decomposability, comprehending each anatomical structure in a whole-to-parts manner. Experimental results are provided across ten tasks, compared to eleven baselines in zero-shot, few-shot transfer, full fine-tuning and settings, and showcase Adam-V2's superior performance over large-scale medical models and existing SSL methods across diverse downstream tasks. The higher generality and robustness of Adam-V2's representations originate from its explicit construction of hierarchies for distinct anatomical structures from unlabeled medical images. Adam-V2 preserves a semantic balance of anatomical diversity and harmony in its embedding, yielding representations that are both generic and semantically meaningful, yet overlooked in existing SSL methods.

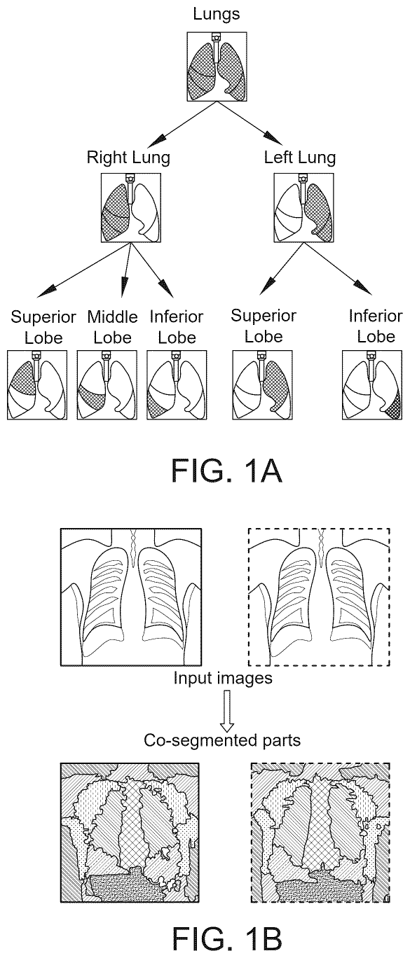

FIGS. 1A and 1B illustrate how human perception effortlessly organizes objects into hierarchies to understand their part-whole relationships in images. Taking lungs as an example in FIG. 1A, even a non-radiologist can form a hierarchy of the right and left lungs, whereas a radiologist can further see the lobes in sub hierarchies. To emulate this ability, the disclosed embodiments introduce a self-supervised learning framework that explicitly learns to encode inherent part whole hierarchies within medical images into an embedding space, leading to the development of a powerful model, referred to herein as Adam-V2, that is foundational to medical imaging. Adam-V2 can transform each pixel in medical images, for example, the chest radiographs in FIG. 1B, into semantically meaningful embeddings, forming multiple “echo chambers”, produced via co-segmentation, in which different anatomical structures are associated with distinct embeddings, and the same anatomical structures have nearly identical embeddings across patients.

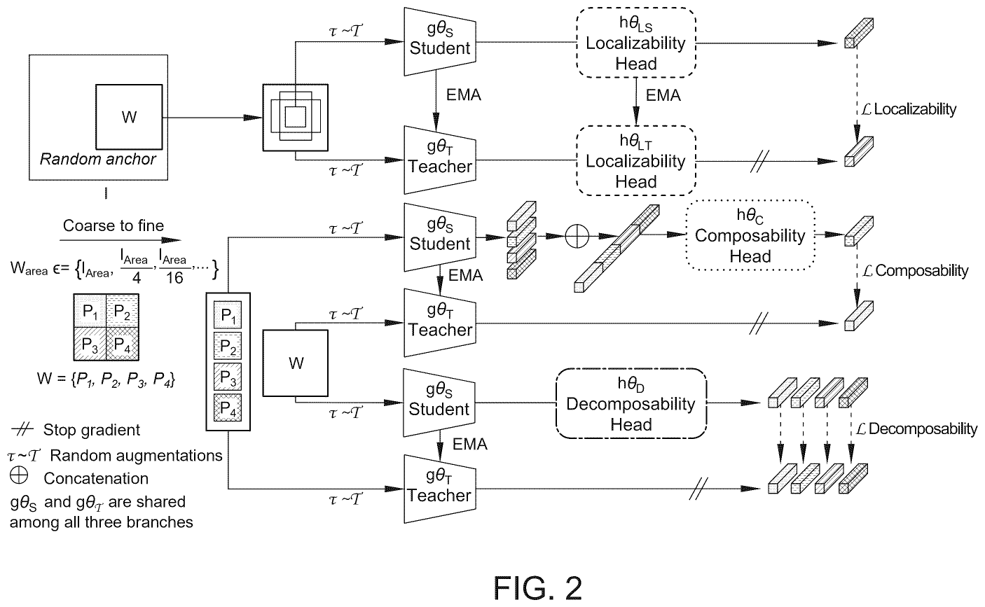

The framework presented in the disclosed embodiments is illustrated in FIG. 2. The framework, Adam-V2, learns hierarchical representations in a coarse-to-fine-manner via three branches: localizability, composability, and decomposability. Given an anchor whole w randomly sampled from image I, the localizability branch augment and process w and its multi-scale views, and enforce consistency between their embeddings, yielding distinct features for different anatomical structures. The composability branch decomposes w into a set of parts and enforces consistency between the embedding of w and the aggregated embeddings of its parts, encoding part-whole relations. The decomposability branch decomposes the embedding of w to acquire the embeddings of its constituent parts and enforce consistency between the embeddings of parts and their decomposed counterparts, capturing whole-part relations.

As mentioned above, the framework comprises three branches: (1) localizability, which compels the model to learn a semantically structured embedding space by discriminating between different anatomical structures, (2) composability, which empowers the model to learn part-whole relations by constructing each anatomical structure through the integration of its constituent parts, and (3) decomposability, which encourages the model to learn whole-part relations by decomposing each anatomical structure into its constituent parts. Unifying these three branches together in a coarse-to-fine learning approach, the localizability branch enables the model to preserve harmony in embeddings of semantically similar anatomical structures in a hierarchy of scales. Simultaneously, composability and decomposability branches empower the model to not only convey hierarchical relationships but also preserve diversity of semantically similar anatomical structures across patients through encoding finer-grained anatomical information of their constituent parts. The disclosed embodiments (i.e., a pretrained model) is referred to herein as Adam-V2 because it represents a significant advancement from previous autodidactic dense anatomical models that learn autodidactically and yield dense anatomical embedding, nicknamed Eve-V2 (embedding vectors) for semantic richness.

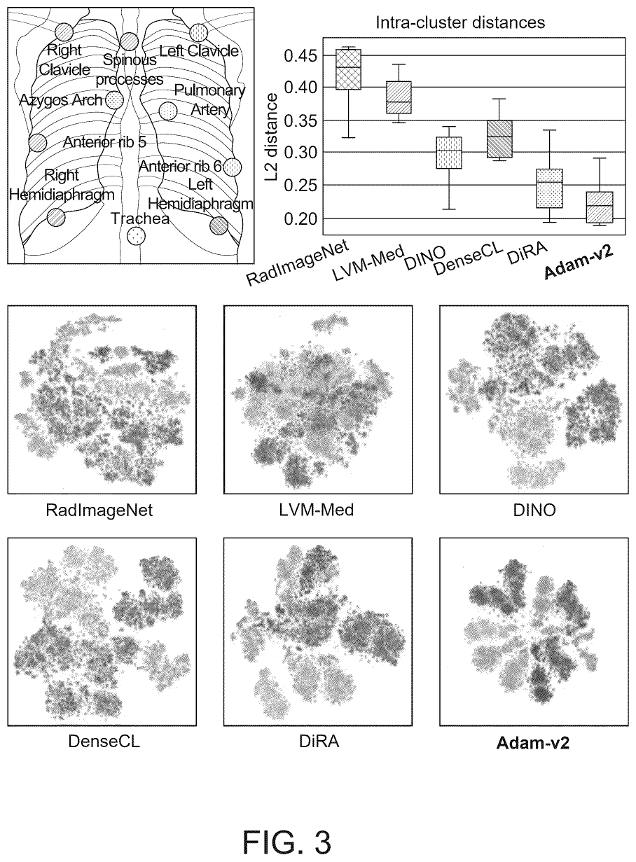

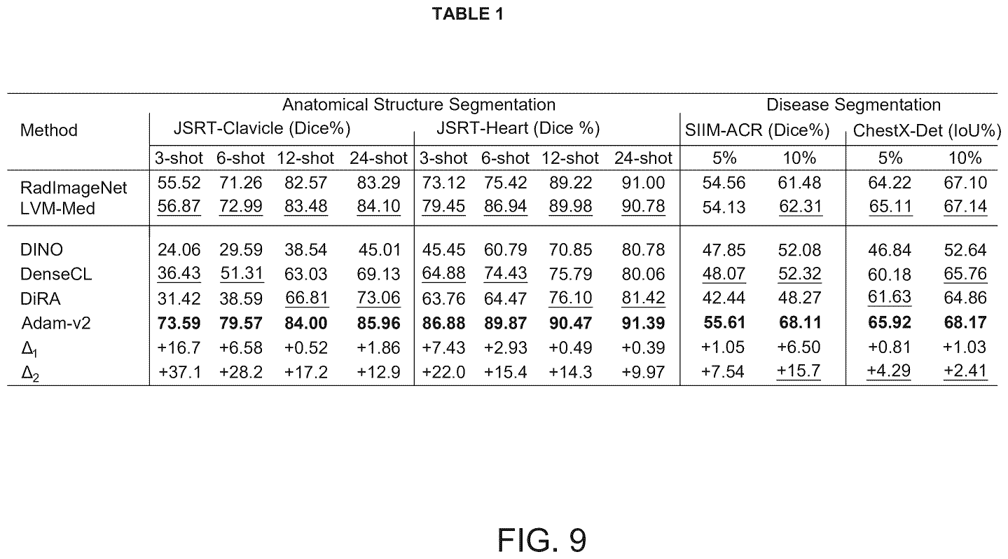

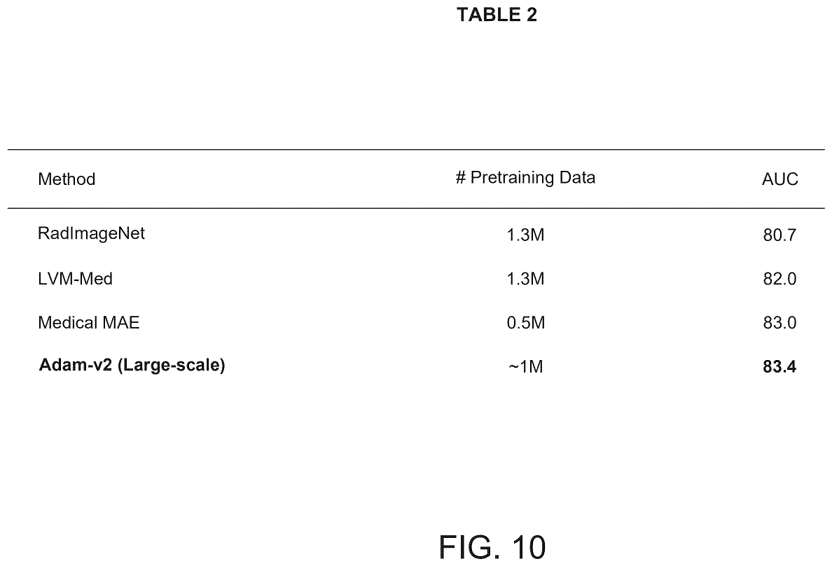

Adam-V2 has been extensively evaluated in (1) Zero-shot settings: Adam-V2 yields more semantically meaningful embeddings (Eve-V2) compared to existing SSL methods with a set of unique properties essential for anatomy understanding (FIGS. 3 to 5); (2) Few-shot transfer-Adam-V2 outperforms two large-scale medical models, RadImageNet and LVM-Med as well as a representative set of seven self-supervised learning (“SSL”) methods by a remarkable margin in anatomical structure and disease segmentation tasks (Table 1, presented in FIG. 9); (3) Full fine-tuning settings: Adam-V2 provides more generalizable representations compared to fully-supervised and SSL baselines across a myriad of tasks (FIG. 2 and Table 2, presented in FIG. 10). Some of the contributions of the embodiments are as follows:

A new self-supervised learning strategy, called Adam-V2, that encodes inherent hierarchical relationships within medical images, yielding discriminative representations blended with semantics of part-whole relations.

A comprehensive set of experiments proves higher generalizability and robustness of Adam-V2 particularly highlighting Adam-V2's proficiency in few shot transfer and achieving a new record in ChestX-rayl4 benchmark.

A set of quantitative and qualitative feature analyses that opens novel perspectives for assessing anatomy understanding from various viewpoints.

### METHOD

A framework, referred to herein as Adam-V2, according to the disclosed embodiments, and as depicted in FIG. 2, aims to underpin the development of powerful self-supervised models foundational to medical imaging by constructing a hierarchy of embeddings learned from anatomy. The framework, according to the disclosed embodiments, comprises three key branches: (1) localizability, aiming to acquire discriminative representations for distinguishing different anatomical structures; (2) composability, aiming to learn each anatomical structure in a parts-to-whole manner; and (3) decomposability, aiming to comprehend each anatomical structure in a whole-to-parts manner. Seamlessly integrating these learning objectives into a unified framework captures inherent hierarchies within medical images, yielding a powerful model (Adam-V2) that can serve not only as the foundation for myriad target tasks via adaptation (fine-tuning), but also its embedding vectors (Eve-V2) bear rich semantics, usable standalone without adaptation (zero-shot), for other tasks like landmark detection.

### Learning Localizability

The localizability branch seeks to learn a semantically-structured embedding space where similar anatomical structures are clustered together and are distinguished from dissimilar anatomical structures. As illustrated in FIG. 2, the localizability branch includes the student g_{θ}S and teacher g_{θ}T encoders, and two projectors h_{θ}LS and h_{θ}LT, referred to as localizability heads. The parameters of student g_{θ}S and localizability head h_{θ}LS are learned with stochastic gradient descent while the parameters of the teacher g_{θ}T and head h_{θ}LT are updated using an exponential moving average (EMA) on the weights of g_{θ}S and h_{θ}LS, respectively. Given an anchor patch w randomly sampled from the input image I, a set C of multi-scale crops is extracted from w. In particular, these crops exhibit diverse dimensions while sharing the same or slightly shifted center as w, contributing to a comprehensive understanding of the same anatomical structure at various resolutions. Random data augmentations T(.) are then applied on w and multi-scale crops in C. The augmented view of w is passed to the teacher, while the augmented views of the crops in C are passed to the student network, generating the features yₜ=g_{θT}(T(w)) and Yₛ={g_{θS}(T(c))|c∈C}, respectively. The localizability heads project the features to the output embeddings zₜ=h_{θ}LT(yₜ) and Zₛ={h_{θ}LS (yₛ)|yₛ∈Yₛ}, which are normalized with a softmax function:

$${{P}_{t} ( {𝓏}_{t} )}^{( i )} = \frac{exp ( {𝓏}_{t}^{( i )} / {τ}_{t} )}{{\sum }_{k = 1}^{K} exp ( {𝓏}_{t}^{( k )} / {τ}_{t} )} , \qquad ( 1 )$$

where τₜ>0 is a temperature parameter controlling the sharpness of the output distribution, and K is the output dimension of the localizability heads. A softmax function Pₛ with temperature τₛ is similarly employed to normalize the features in Zs. The localizability branch's objective is to maximize the consistency between the embeddings of the input anchor and its augmented views. To do so, cross-entropy loss is employed:

$${ℒ}_{Locali𝓏ability} = - \frac{1}{\vert {Z}_{s} \vert} {\sum }_{{𝓏}_{s} ∈ {Z}_{s}} {P}_{t} ( {𝓏}_{t} ) log {P}_{s} ( {𝓏}_{s} ) \qquad ( 2 )$$

It is noteworthy that the framework offers flexibility in utilizing various localizability loss functions. While embodiments opt for a self-distillation loss due to its simplicity and efficiency, alternative sophisticated objectives, such as contrastive loss, can also be employed.

### Learning Composability

The composability branch seeks to learn the part-whole anatomical hierarchies in a bottom-up manner by assembling larger anatomical structures from their smaller constituent subparts. With reference to FIG. 2, LCD learns hierarchical representations in a coarse-to-fine-manner via three branches: localizability, composability, and decomposability. Given an anchor whole w randomly sampled from image I, the localizability branch augments and processes w and its multi-scale views, and enforces consistency between their embeddings, yielding distinct features for different anatomical structures. The composability branch decomposes w into a set of parts and enforces consistency between the embeddings of w and the aggregated embeddings of its parts, encoding part-whole relations. The decomposability branch decomposes the embeddings of w to acquire the embeddings of its constituent parts and enforces consistency between the embeddings of parts and their decomposed counterparts, capturing whole-part relations.

As illustrated in FIG. 2, the composability branch consists of the student g_{θS} and teacher g_{θT} encoders, which are shared with the localizability branch, and a composability head h_{θC}. Given an anchor whole w randomly sampled from the input image I, embodiments decompose it into a set of n non-overlapping parts P={pi}ⁿᵢ₌₁. The parts are augmented and processed by the student network, generating parts' embeddings Yps={yi=g_{θS}(T(pi))}ⁿᵢ₌₁. The parts' embeddings are then concatenated and passed to the composability head h_{θC} to produce the aggregated embeddings of parts zₚₛ=h_{θC}(⊕({yi}ⁿᵢ₌₁)). Moreover, the whole anatomical structure w is augmented and passed to the teacher network to generate the whole's embeddings z_{wt}=g_{θT} (T(w)). The composability branch is trained to maximize the agreement between the whole's embeddings and the aggregated embeddings of its parts:

$${ℒ}_{Composability} = {ℓ}_{s} ( {𝓏}_{wt} , {𝓏}_{p s} ) \qquad ( 3 )$$

where [symbol] ₛ(z_{wt}, zₚₛ) presents a function that measures similarity between z_{wt} and zₚₛ, such as MSE, cross-entropy, or cosine similarity.

### Learning Decomposability

The decomposability branch seeks to learn the whole-part anatomical hierarchies in a top-down manner by decomposing larger anatomical structures into their smaller constituent subparts. As shown in FIG. 2, the decomposability branch comprises the student g_{θS} and teacher g_{θT} encoders, which are shared with the localizability and composability branches, and a decomposability head h_{θD}. Given an anchor whole w, embodiments decompose it into a set of n non-overlapping parts P={pᵢ}ⁿᵢ₌₁. The anchor whole w is augmented and fed into the student network, producing the whole's embeddings z_{ws}=g_{θS}(T(w)). The whole's embeddings are then passed to the decomposability head h_{θD}, which decomposes them into a set of individual embed-dings corresponding to the constituent parts of the whole Zₚₛ=h_{θD}(z_{ws}). Additionally, the parts P={pi}ⁿᵢ₌₁ are augmented and processed by the teacher network, generating parts' embeddings Zₚₜ={gor (T(pi))}ⁿᵢ₌₁. The decomposability branch is trained to maximize the agreement between the embeddings of the individual parts and their decomposed counterparts:

$${ℒ}_{Decomposability} = \frac{1}{\vert P \vert} {\sum }_{i = 1}^{\vert P \vert} {ℓ}_{s} ( {𝓏}_{pi} , {𝓏}_{{p}_{i}^{′}} ) \qquad ( 4 )$$

where zₚᵢ ∈Zₚₜ and zₚ′ᵢ ∈Zₚₛ, and [symbol] ₛ (zₚᵢ, zp′) presents a function that measures similarity between zₚi and zₚ′i, such as MSE, cross-entropy, or cosine similarity.

### Training Pipeline

To guide the model in learning hierarchical representations, embodiments consider a hierarchy of diverse anatomical structures at various scales. Specifically, the highest level of the hierarchy represents entire images (of spatial resolution (H×W)) with complete anatomy, while each subsequent level m∈{1, 2 . . . } represents anatomical structures ω at a scale of (H/2^{m}×W/2^{m}), randomly sampled from the images. In a coarse-to-fine manner, the anatomical structures w at each level are fed as the input to the localizability, composability, and decomposability branches, and are learned through the following combined loss function:

$$ℒ = {λ}_{1} * {ℒ}_{Localizability} + {λ}_{2} * {ℒ}_{Composability} + {λ}_{3} * {ℒ}_{Decomposability} \qquad ( 5 )$$

where λ₁, λ₂, λ₃ are coefficients denoting the weight of each loss term. Through a unified training scheme, Adam-V2 learns a rich embedding space preserving harmony among similar anatomical structures and encoding their hierarchical relations. In particular, the localizability loss term encourages the model to capture distinctive embeddings for different anatomical structures across varying scales. Moreover, the composability and decomposability loss terms empower the model with a profound understanding of the part-whole relations in both bottom-up and top-down manners.

Thus, according to embodiments of the invention, disclosed herein is a method performed by a system having at least a processor and a memory therein to execute instructions for a self-supervised learning framework to learn visual representations of medical images of semantically similar anatomical structures of a plurality of patients. The Adam-V2 framework learns via a localizability branch of the framework a semantically structured embedding space by discriminating between different anatomical structures, learns via a composability branch of the framework part-whole hierarchical relationships of the anatomical structures by constructing each anatomical structure through an integration of parts, and learns via a decomposability branch of the framework whole-part hierarchical relationships of the anatomical structures by decomposing each anatomical structure into its parts.

According to embodiments, the learning via the localizability branch of the framework the semantically structured embedding space by discriminating between different anatomical structures may involve clustering similar anatomical structures together and distinguishing the similar anatomical structures from dissimilar anatomical structures.

According to embodiments, the learning via the localizability branch of the framework the semantically structured embedding space by discriminating between different anatomical structures includes learning with a stochastic gradient descent parameters of a student network comprising a student encoder and a student head, and learning, using an exponential moving average of weights for the student encoder and the student head, parameters of a teacher network comprising a teacher encoder and teacher head.

According to embodiments, the learning via the localizability branch of the framework the semantically structured embedding space by discriminating between different anatomical structures involves the steps of: receiving a medical image, I, as an input; randomly sampling an anchor patch w from the input medical image; extracting a set C of multi-scale crops from the anchor patch w; applying random data augmentations T to the anchor patch w and the multi-scale crops in the set C; and generating the features y: =g_{θT} (T(w)) and Ys={g_{θS} (T(c))| c E C}.

According to embodiments, generating the features yr=g_{θT} (T(w)) and Ys={gos (T(c))| c E C} may include the steps of transmitting the random data augmentations of the anchor patch to the teacher network, and transmitting the random data augmentation of the plurality of multi-scale crops to the student network.

According to embodiments, an additional step may include projecting via the student and teacher heads the features to output embeddings z=h_{θ}LT(yt) and Zs={hoLS (ys)| ys E Ys}, normalizing the output embeddings z with a softmax function, and normalizing the features in zs with another, different, softmax function.

According to embodiments, the learning via the composability branch of the framework part-whole hierarchical relationships of the anatomical structures by constructing each anatomical structure through an integration of parts involves decomposing w into a set of parts and enforcing consistency between embeddings of w and aggregated embeddings of its parts, encoding part-whole relations.

According to embodiments, the learning via the composability branch of the framework part-whole hierarchical relationships of the anatomical structures by constructing each anatomical structure through an integration of parts may involve: receiving the medical image, I, as an input; randomly sampling an anchor whole w from the input medical image; decomposing the randomly sampled anchor whole w into a set of n non-overlapping parts; augmenting via the student network the set of n non-overlapping parts to generate parts' embeddings Yps={yi=g_{θS}(T(pi))}ⁿᵢ₌₁; concatenating and transmitting the parts' embeddings to a composability branch head to produce aggregated parts' embeddings zps=h_{θC}(⊕({yᵢ}ⁿᵢ₌₁); and augmenting and transmitting the whole anatomical structure w to the teacher network to generate the whole anatomical structure w's embeddings z_{wt}=g_{θT}(T(w)).

According to embodiments, the decomposing each anatomical structure into its parts involves decomposing each random anchor (w) into a plurality of non-overlapping parts.

According to embodiments, the learning via a decomposability branch of the framework whole-part hierarchical relationships of the anatomical structures by decomposing each anatomical structure into its parts comprises: receiving the medical image, I, as an input; randomly sampling an anchor whole w from the input medical image; decomposing the randomly sampled anchor whole w into a set of n non-overlapping parts P={pᵢ}ⁿᵢ₌₁; augmenting via the student network the set of n non-overlapping parts to generate whole embeddings z_{ws}=g_{θS}(T(w)); transmitting the whole embeddings to the decomposability branch head to produce a set of individual embeddings corresponding to constituent parts of the whole Zₚₛ=heD (Zws); and augmenting and processing by the teacher network the set of n non-overlapping parts P={pᵢ}” i=1 to generate parts' embeddings Zₚₜ= {g_{θT} (T(pᵢ))} “;=1.

### IMPLEMENTATION DETAILS

Pretraining protocol. Embodiments use unlabeled images chest radiographs and color fundus photographs for pretraining Adam-V2 on two imaging modalities. The SSL framework is architecture-neutral and compatible with any ConvNet and vision transformer backbones. As an illustration, Adam-V2 is pre-trained with ResNet-50, ViT-S, and ConvNeXt-B backbones. Embodiments follow in optimization settings (e.g. optimizer, learning rate schedule, τₜ, τₛ, etc.), updating teacher weights, and architecture of hers and her heads. h_{θC} and h_{θD} are two-layer MLP heads. Embodiments use MSE as {(.) in Eqs. (3) and (4). λ₁, λ₂, λ₃ are set to 1, n to 4, and m up to 4. In localizability branch, embodiments extract one 224² global view and eight 96² multi-scale crops from w to ensure a marginal increase in compute cost. For other branches, embodiments use input resolution 224². Data augmentation T(.) includes color jittering, Gaussian blur, and rotation. To prove the scalability of the framework, a large-scale model was trained using ConvNeXt-B backbone and a large corpus of 926,028 images collected from thirteen different public chest X-ray datasets.

Evaluations. Embodiments are evaluated in zero-shot, few-shot learning, and feature analysis. Evaluations considered ten downstream tasks on nine publicly available datasets for transfer learning, including JSRT, VinDR-Rib, ChestX-Det, SIIM-ACR, VinDr-CXR, NIH Shenzhen, ChestX-rayl4, DRIVE, and Drishti-GS. These tasks rigorously assess Adam-V2's generalizability across various applications, diseases, anatomical structures, and modalities.

Baselines. Adam-V2 is compared with a representative set of seven SOTA publicly-available SSL baselines, encompassing ConvNet- and transformer-based methods. These baselines represent diverse objectives at instance-, patch-, and pixel-level, among which TransVW, PCRL, DiRA, and Medical-MAE represent SOTA methods tailored for medical tasks. All SSL baselines are pre-trained on the same datasets as Adam-V2 by following their official settings. Moreover, Adam-V2 is compared with the publicly available and official models of two recent large-scale medical models: RadImageNet and LVM-Med, pre-trained on 1.3 million medical images in fully-supervised and self-supervised manners, respectively.

Fine-tuning protocol. Following the standard transfer learning protocol, Adam-V2's pretrained teacher network has been fine-tuned for (1) classification tasks by appending a task-specific head, and (2) segmentation tasks that employ a U-Net network, initializing the encoder with the pre-trained weights. Each method is run at least five times for each task. Statistical analysis is provided using an independent two-sample t-test.

### RESULTS AND ANALYSIS

Adam-V2 demonstrates zero shot anatomy understanding, offering semantics rich embeddings over existing SSL methods. The following discussion showcases the anatomy understanding capabilities of the framework according to the disclosed embodiments by delving into the unique learned and emergent properties of Adam-V2's embeddings in various zero shot settings.

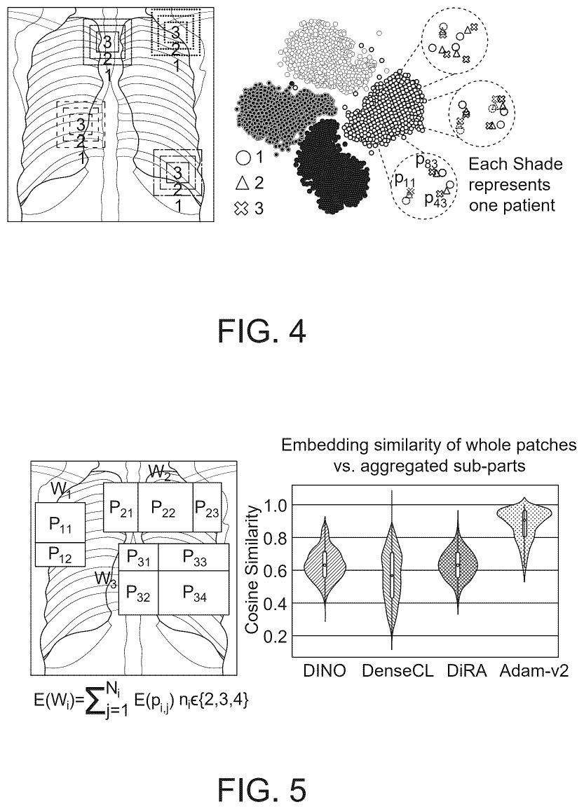

Localizability: Adam-V2's capability in discriminating different anatomical structures is investigated to determine if the learned embeddings (Eve-V2) preserve the locality of anatomical structures. To do so, a dataset of 1,000 images is created from the ChestX-ray 14 dataset with ten distinct anatomical landmarks manually annotated by human experts in each image (see FIG. 3 where Adam-V2 learns localizability of anatomical structures, providing discriminative features for different landmarks. Same-shaded points are instances of the same landmark across images). Patches of size 224² are extracted from around each landmark's location across images and extract latent features of each landmark instance using each pretrained model under study (with no fine-tuning). The embeddings are then visualized with a t-SNE plot. Adam-V2 is compared with the RadImageNet, LVM-Med and a representative set of SSL methods. As seen in FIG. 3, the baselines fall short in generating distinct features for different landmarks, leading to ambiguous embedding spaces with mixed clusters. By contrast, Adam-V2 effectively discriminates between various anatomical landmarks, resulting in well-separated clusters within its learned embedding space. The qualitative results (t-SNE plots) are complemented with quantitative results (box plots) by calculating intra-cluster distance for each landmark class and visualizing the distances distributions with boxplots in FIG. 3. As seen, Adam-V2 exhibits lower median distances, indicating more cohesive clusters, compared to the baselines. To showcase Adam-V2's capacity in balancing anatomical diversity and harmony and conveying hierarchical relationships, four distinct anatomical landmarks are randomly selected, and three patches of different resolutions (labeled as levels 1, 2, and 3) are extracted around each landmark across the images, and their embeddings computed with Adam-V2's pretrained model. As depicted in FIG. 4, the embeddings of anatomical structures at levels 1, 2, and 3 for each landmark are closely aligned, highlighting Adam-V2's capability to preserve harmony in embeddings of semantically similar anatomical structures across resolutions and patients. Additionally, within each landmark, the embeddings of patches with levels 1, 2, and 3 for the same patient (shaded in FIG. 4) are close, while those of different patients are well separated, representing Adam-V2's capability to preserve diversity of anatomical structures across patients.

Composability & Decomposability: Adam-V2's ability to capture part-whole hierarchies, as imposed by the composability and decomposability branches, in its learned embeddings (Eve-V2), is explored. To do so, random patches of varying sizes, called whole, are extracted from ChestX-ray 14 test images. Each whole is decomposed into 2, 3, or 4 non-overlapping parts with different sizes. Embodiments resize each whole and its parts to 224², extract features using pretrained models, and calculate the cosine similarity between the embedding of each whole and the aggregate of its parts. As seen in FIG. 5, the box plot elements indicate that the median similarity for Adam-V2 is significantly higher than that of other baseline approaches. Additionally, the distribution of Adam-V2's similarity values is highly concentrated around the 1.5× interquartile, situated at the top of the box plot. This concentration suggests that, in most cases, the similarity value between the embedding of entire wholes and their aggregated parts is closer to 1 in the Adam-V2 model.

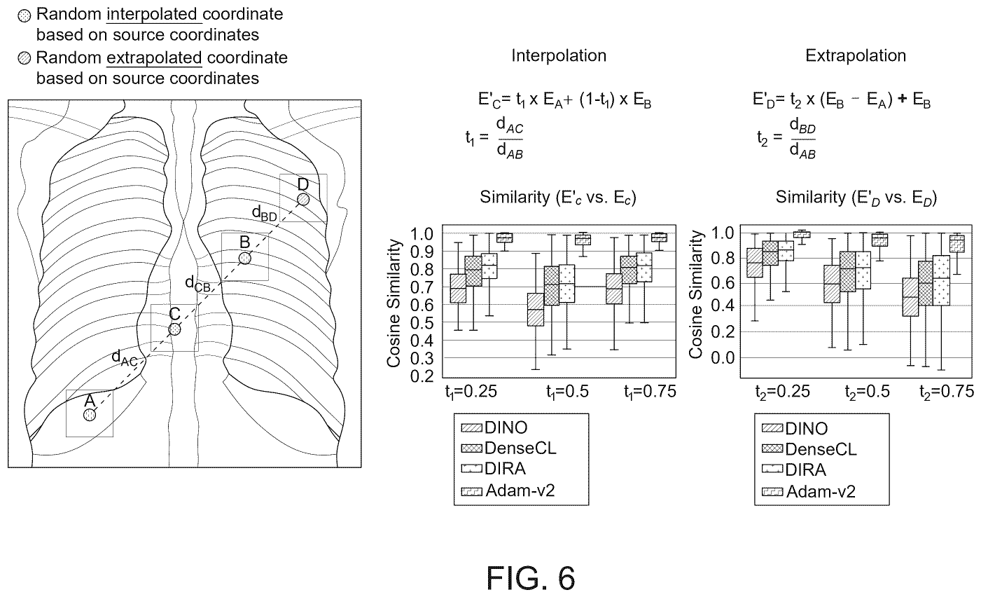

Interpolation and Extrapolation: Adam-V2's capability to interpolate/extrapolate embeddings are investigated for a randomly chosen anatomical structure by leveraging the embeddings of two other randomly selected anatomical structures. For interpolation, embodiments select two random source coordinates (labeled as A and B in FIG. 6) and use the established interpolation formula (refer to FIG. 6) to interpolate a random point C. Embodiments extract 224² patches around points A, B, and C and pass them through each pretrained model under study to extract their respective embeddings E_{A}, E_{B}, and E_{C}, where E_{C} serves as the ground truth for evaluating the interpolated embeddings for C. Subsequently, embodiments apply the interpolation formula to generate embeddings for C based on E_{A} and E_{B}, resulting in interpolated embeddings E′_{C} and the ground truth E_{C}. This process was repeated for 1,000 images selected from the test images of Chest X-ray 14, employing three different values of t₁(i.e., 0.25, 0.5, and 0.75). Boxplots were used to illustrate the similarity distributions in each setting. Embodiments examine extrapolation of embeddings for a randomly selected point D in a similar manner using the extrapolation formula. The boxplots in FIG. 6 reveal the consistent superiority of Adam-V2 in delivering higher similarity between interpolated/extrapolated embeddings and the ground truth (with a median close to 1) compared to other baselines. This outstanding performance is indicative of the Adam-V2's capability in establishing relations between anatomical structures. It is noteworthy that the Adam-V2 model was not explicitly trained for these properties, and their emergence underscores the Adam-V2's capabilities in understanding anatomy.

### Adam-V2 Excels in Few-Shot Transfer, Outperforming SOTA Fully/Self-Supervised Methods in Segmentation Tasks

The following discussion highlights the effectiveness of Adam-V2 as an effective foundation for fine-tuning deep models in segmentation tasks with limited labeled data. Adam-V2 is compared with 3 SSL methods, as well as RadImageNet and LVM-Med models, which serve as performance upper bounds. Experiments were conducted on heart and clavicle segmentation tasks, fine-tuning the pretrained models using a few shots of labeled data randomly sampled from the JSRT dataset. Moreover, experiments were conducted on various thoracic disease segmentation tasks, fine tuning the pretrained models on two randomly selected label fractions (5% and 10%) of the SIIM-ACR and ChestX-Det datasets. As seen in Table 1 presented in FIG. 9, Adam-V2 outperforms both RadImageNet and LVM-Med across all label fractions in all tasks. For instance, in the 3-shot transfer for clavicle and heart segmentation tasks, Adam-V2 surpasses LVM-Med by at least 16% and 7%, respectively. Moreover, Adam-V2 provides outstandingly better few-shot transfer performance compared with SSL methods across all tasks. For instance, in the pneumothorax segmentation task within the SIIM-ACR dataset, Adam-V2 surpasses the runner-up baseline by 7.54% and 15.7% in the 5% and 10% labeled data subsets, respectively. Similarly, across the 5% and 10% fractions of the ChestX-Det dataset, Adam-V2 demonstrates notably higher averages of 4.29% and 2.41% in the thoracic diseases segmentation task. The attribution of Adam-V2's superior representations for few-shot segmentation tasks is grounded in the significance of anatomy learning through the SSL approach and its profound impact on representation learning, which is neglected in existing methods.

### Adam-V2 Stands Out in Full Transfer, Unleashing Generalizable Representations for a Variety of Tasks

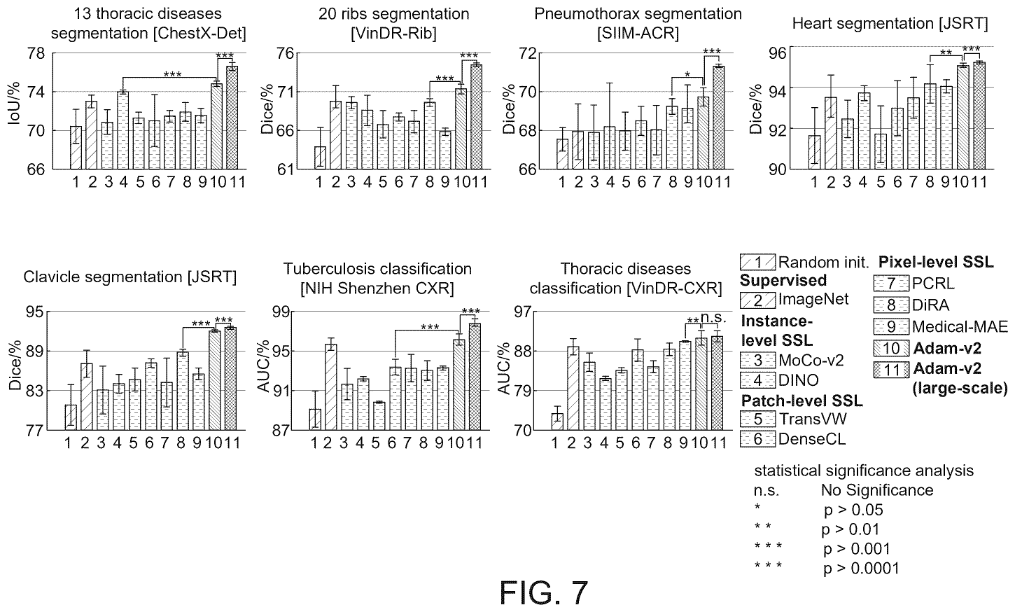

The following discussion demonstrates the generalizability of Adam-V2's representations via transfer learning to a broad range of downstream tasks in a full fine-tuning setting. Adam-V2 is compared with seven state of the art (SOTA) ConvNet- and vision transformer-based SSL methods designed for both computer vision and medical applications. Training downstream models is included from random initialization (the lower-bound baseline) and fully-supervised ImageNet model. As seen in FIG. 7, Adam-V2 consistently achieves superior performance compared with the fully-supervised ImageNet model, as well as significant performance boosts (p<0.05) compared with all SSL counterparts across all tasks.

Comparison in Public ChestX-rayl4 Benchmark. To scrutinize the scalability of the framework, Adam-V2 was pretrained with the ConvNeXt-B backbone on nearly 1M chest X-ray images and compared against officially released large-scale medical vision models in the ChestXray 14 benchmark. As seen in Table 2 presented in FIG. 10, Adam-V2 hits a new record of 83.4 in the ChestX-ray 14 benchmark. This suggests that a meticulously crafted learning strategy that comprehends human anatomy can fully harness large-scale data, thereby paving the way for developing powerful self-supervised models foundational to medical imaging.

### Ablation Experiments

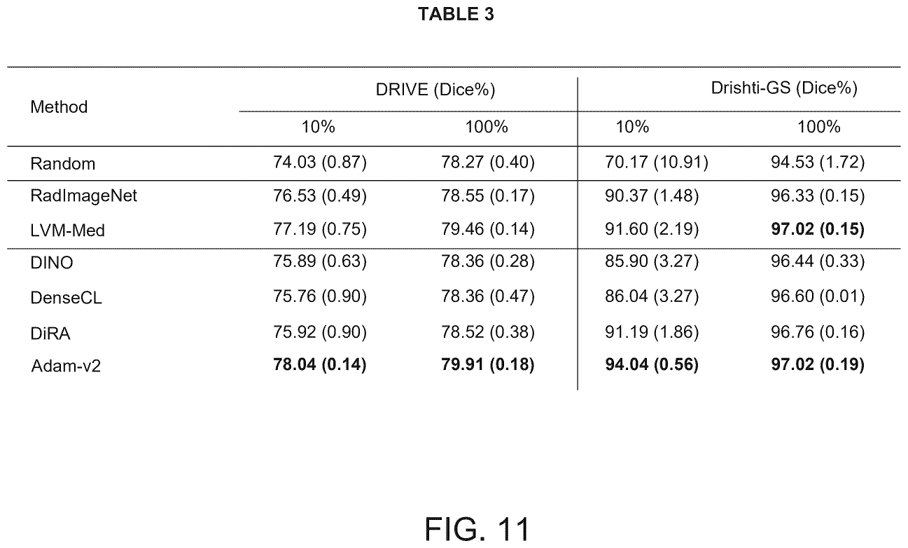

Generalizability of framework. According to embodiments, the framework can seamlessly extend to other imaging modalities. To demonstrate this, consider fundus images and pretrain Adam-V2 using the EyePACS dataset and then fine-tune it for two downstream tasks, considering both low-data regimes and full fine-tuning settings. As seen in Table 3 presented in FIG. 11, Adam-V2 exhibits superior performance (p<0.05) across tasks in both settings compared with SSL baselines that leverage the same pretraining data as Adam-V2. Moreover, Adam-V2 outperforms (p<0.05) RadImageNet and LVM-Med models in low-data regimes and achieves superior or equivalent performance in full fine-tuning scenarios.

Effect of learning objectives. The impact of each learning branch in Adam-V2 is assessed by starting from localizability and incrementally adding composability and decomposability learning. Embodiments fine-tune the models for two downstream tasks. As seen in the top-row of FIG. 7, augmenting localizability with composability learning consistently improves performance across tasks. Moreover, the inclusion of decomposability further enhances the performance, resulting in significant performance boosts (p<0.05) in both tasks compared to standalone localizability learning.

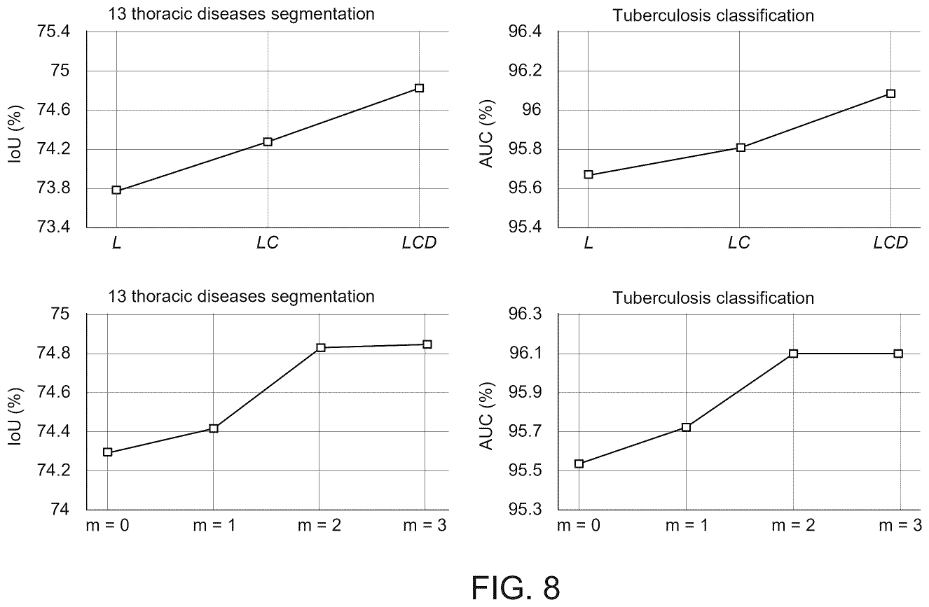

Effect of coarse-to-fine learning. The impact of hierarchical learning of anatomical structures at various scales (i.e., m) is investigated by initially training Adam-V2 with the entire anatomy (m=0) and then progressively delving deeper into the higher levels of anatomy hierarchy (up to level 3), representing finer anatomical structures. As seen in the bottom-row of FIG. 8, gradual increment of data granularity from m=0 to m=2 consistently improves the downstream performance. This underscores that coarse-to-fine learning strategy incrementally deepens the model's anatomical knowledge, resulting in more generic representations for myriad tasks. Additionally, no significant change in performance is observed at m=3, suggesting that pretraining up to level 2 yields sufficiently robust representations.

### Related Work

Self-supervised learning. A large body of work on SSL methods seeks to learn global features via instance discrimination pretext tasks. These methods align the features of augmented views from the same image by employing diverse learning objectives, including contrastive methods, self-distillation methods, and feature decorrelation methods Alternatively, dense SSL methods seek to learn local features by encoding visual patterns embedded at smaller image regions. Dense contrastive learning methods enforce consistency between pixels at the same spatial location, similar pixels/patches in a feature map, or similar image regions. On the other hand, masked image modeling methods mask random portions of the images and reconstruct the missing parts at pixel-level. Motivated by the success in computer vision, a broad variety of instance discrimination and image reconstruction methods, along with their integration, have been explored for medical imaging. Given such advancements, the evolution of SSL has empowered it to serve as the cornerstone for developing foundation models with broad applicability. However existing SSL methods overlook anatomy hierarchies in their learning objectives, thereby lacking anatomy understanding capabilities. By contrast, Adam-V2 exploits the hierarchical nature of anatomy to learn semantics-rich features, leading to more pronounced models tailored for medical tasks.

Learning from anatomy. Consistent anatomy in medical imaging provides strong yet free supervision signals for deep models to learn common anatomical representations via self-supervision. Existing works revolve around recovering anatomical patterns from transformed images, learning semantics of recurrent anatomical patterns across patients with subsequent enhancements via adversarial learning, exploiting spatial relationships in anatomy, utilizing global and local anatomical consistency, and incorporating anatomical cues to improve contrastive learning. These existing works neglect hierarchical anatomy relations. Although a previous method named Adam uses anatomy hierarchies as soft supervisory signals, Adam-V2 explicitly encodes part-whole hierarchies via its learning objectives. Compared with Adam, Adam-V2 showcases two significant advancements: (1) enhancing the localizability branch by eliminating negative pairs pruning, thereby improving computational efficiency for large-scale pretraining, (2) introducing two novel components: composability and decomposability, which are crucial for capturing part-whole hierarchies.

Learning part-whole hierarchies. Hierarchical representation learning is ingrained in architectures such as ConvNets and hierarchical ViTs. However, the multi-scale feature hierarchy of common neural networks does not explicitly align with the part-whole hierarchy in images, leading to the advent of new architecture designs aimed at encoding part-whole hierarchies. Notably, GLOM introduced a conceptual framework that utilizes attention to represent part-whole hierarchies, and subsequent works have proposed ViT-based architectures to implement it. The disclosed embodiments of Adam-V2 go beyond architecture design by introducing a new learning strategy that encodes the semantics of part-whole hierarchies into the embedding space through three explicit training objectives: localizability, composability, and decompsability.

### CONCLUSION

Adam-V2 is a self-supervised learning strategy or framework that aims to enhance visual representations by creating a hierarchy of embeddings for different anatomical structures. One novelty of the method is explicitly enforcing part-whole hierarchies in an SSL framework via three learning objectives. Experiments highlight the effectiveness of Adam-V2 in various tasks, surpassing a range of baselines and demonstrate the semantic richness of learned representations, which stem from explicitly acquired or autonomously emerging unique properties.

Embodiments of the invention contemplate a machine or system within which embodiments may operate, be installed, integrated, or configured. In accordance with one embodiment, the system includes at least a processor and a memory therein to execute instructions including implementing any application code to perform any one or more of the methodologies discussed herein. Such a system may communicatively interface with and cooperatively execute with the benefit of remote systems, such as a user device sending instructions and data, a user device to receive output from the system.

A bus interfaces various components of the system amongst each other, with any other peripheral(s) of the system, and with external components such as external network elements, other machines, client devices, cloud computing services, etc. Communications may further include communicating with external devices via a network interface over a Local Area Network (“LAN″), Wide Area Network (“WAN”), or the public Internet.

In alternative embodiments, the system may be connected (e.g., networked) to other machines in a LAN, an intranet, an extranet, or the public Internet. The machine may operate in the capacity of a server or a client machine in a client-server network environment, as a peer machine in a peer-to-peer (or distributed) network environment, as a server or series of servers within an on-demand service environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify and mandate the specifically configured actions to be taken by that machine pursuant to stored instructions. Further, the term “machine” shall also be taken to include any collection of machines (e.g., computers) that individually or jointly execute a set (or multiple sets) of instructions to perform any one or more of the methodologies discussed herein.

An exemplary computer system includes a processor, a main memory (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory (e.g., a persistent storage device including hard disk drives and a persistent database and/or a multi-tenant database implementation), which communicate with each other via a bus. Main memory includes code that implements the three branches of the SSL framework described herein, namely, the localizability branch, the composability branch, and the decomposability branch.

The processor represents one or more specialized and specifically configured processing devices such as a microprocessor, central processing unit, or the like. More particularly, the processor may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor may also be one or more special-purpose processing devices such as an application-specific integrated circuit (ASIC), a field programmable gate array (FPGA), a digital signal processor (DSP), network processor, or the like. The processor is configured to execute processing logic for performing the operations and functionality discussed herein.

The system may further include a network interface card. The system also may include a user interface (such as a video display unit, a liquid crystal display, etc.), an alphanumeric input device (e.g., a keyboard), a cursor control device (e.g., a mouse), and a signal generation device (e.g., an integrated speaker). According to an embodiment of the system, the user interface communicably interfaces with a user client device remote from the system and communicatively interfaces with the system via a public Internet.

The system may further include peripheral devices (e.g., wireless or wired communication devices, memory devices, storage devices, audio processing devices, video processing devices, etc.).

A secondary memory may include a non-transitory machine-readable storage medium or a non-transitory computer readable storage medium or a non-transitory machine-accessible storage medium on which is stored one or more sets of instructions (e.g., software) embodying any one or more of the methodologies or functions described herein. The software may also reside, completely or at least partially, within the main memory and/or within the processor during execution thereof by the system, the main memory and the processor also constituting machine-readable storage media. The software may further be transmitted or received over a network via the network interface card.

In addition to various hardware components depicted in the figures and described herein, embodiments further include various operations which are described herein. The operations described in accordance with such embodiments may be performed by hardware components or may be embodied in machine-executable instructions, which may be used to cause a specialized and special-purpose processor having been programmed with the instructions to perform the operations described herein. Alternatively, the operations may be performed by a combination of hardware and software. In such a way, the embodiments of the invention provide a technical solution to a technical problem.

Embodiments also relate to an apparatus for performing the operations disclosed herein. This apparatus may be specially constructed for the required purposes, or it may be a special purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

While the algorithms and displays presented herein are not inherently related to any particular computer or other apparatus, they are specially configured and implemented via customized and specialized computing hardware which is specifically adapted to more effectively execute the novel algorithms and displays which are described in greater detail herein. Various customizable and special purpose systems may be utilized in conjunction with specially configured programs in accordance with the teachings herein, or it may prove convenient, in certain instances, to construct a more specialized apparatus to perform the required method steps. The required structure for a variety of these systems will appear as set forth in the description. In addition, embodiments are not described with reference to any particular programming language. It will be appreciated that a variety of programming languages may be used to implement the teachings of the embodiments as described herein.

Embodiments may be provided as a computer program product, or software, that may include a machine-readable medium having stored thereon instructions, which may be used to program a computer system (or other electronic devices) to perform a process according to the disclosed embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical), etc.

Any of the disclosed embodiments may be used alone or together with one another in any combination. Although various embodiments may have been partially motivated by deficiencies with conventional techniques and approaches, some of which are described or alluded to within the specification, the embodiments need not necessarily address or solve any of these deficiencies, but rather, may address only some of the deficiencies, address none of the deficiencies, or be directed toward different deficiencies and problems which are not directly discussed.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as are apparent to those skilled in the art. Therefore, the scope of the appended claims is to be accorded the broadest interpretation to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A method performed by a system having at least a processor and a memory therein to execute instructions for a self-supervised learning framework to learn visual representations of medical images of semantically similar anatomical structures of a plurality of patients, comprising:
learning via a localizability branch of the framework a semantically structured embedding space by discriminating between different anatomical structures;
learning via a composability branch of the framework part-whole hierarchical relationships of the anatomical structures by constructing each anatomical structure through an integration of parts; and
learning via a decomposability branch of the framework whole-part hierarchical relationships of the anatomical structures by decomposing each anatomical structure into its parts.

2. The method of claim 1 wherein learning via the localizability branch of the framework the semantically structured embedding space by discriminating between different anatomical structures comprises clustering similar anatomical structures together and distinguishing the similar anatomical structures from dis-similar anatomical structures.

3. The method of claim 1, wherein learning via the localizability branch of the framework the semantically structured embedding space by discriminating between different anatomical structures comprises:
learning with a stochastic gradient descent parameters of a student network comprising a student encoder and a student head; and
learning, using an exponential moving average of weights for the student encoder and the student head, parameters of a teacher network comprising a teacher encoder and teacher head.

4. The method of claim 3, wherein learning via the localizability branch of the framework the semantically structured embedding space by discriminating between different anatomical structures comprises:
receiving a medical image, I, as an input;
randomly sampling an anchor patch w from the input medical image;
extracting a set C of multi-scale crops from the anchor patch w;
applying random data augmentations T to the anchor patch w and the multi-scale crops in the set C; and
generating the features yₜ=g_{θT}(T(w)) and Yₛ={g_{θS}(T(c))|c∈C}.

5. The method of claim 4, wherein generating the features yₜ=g_{θT}(T(w)) and Yₛ={g_{θS} (T(c))|c∈C} comprises:
transmitting the random data augmentations of the anchor patch to the teacher network; and
transmitting the random data augmentation of the plurality of multi-scale crops to the student network.

6. The method of claim 4, further comprising:
projecting via the student and teacher heads the features to output embeddings zₜ=h_{θ}LT(yₜ) and Zₛ={h_{θ}LS (yₛ)|yₛ∈Yₛ};
normalizing the output embeddings zₜ with a softmax function; and
normalizing the features in zₛ with another, different, softmax function.

7. The method of claim 1 wherein learning via the composability branch of the framework part-whole hierarchical relationships of the anatomical structures by constructing each anatomical structure through an integration of parts comprises decomposing w into a set of parts and enforcing consistency between embeddings of w and aggregated embeddings of its parts, encoding part-whole relations.

8. The method of claim 4, wherein learning via the composability branch of the framework part-whole hierarchical relationships of the anatomical structures by constructing each anatomical structure through an integration of parts comprises:
receiving the medical image, I, as an input;
randomly sampling an anchor whole w from the input medical image;
decomposing the randomly sampled anchor whole w into a set of n non-overlapping parts;
augmenting via the student network the set of n non-overlapping parts to generate parts' embeddings Yps={yi=g_{θS}(T(pᵢ))}ⁿᵢ₌₁;
concatenating and transmitting the parts' embeddings to a composability branch head to produce aggregated parts' embeddings zₚₛ=h_{θC}(⊕({yᵢ}ⁿᵢ₌₁)); and
augmenting and transmitting the whole anatomical structure w to the teacher network to generate the whole anatomical structure w's embeddings z_{wt}=g_{θT}(T(w)).

9. The method of claim 1, wherein decomposing each anatomical structure into its parts comprises decomposing each random anchor (w) into a plurality of non-overlapping parts.

10. The method of claim 4, wherein learning via a decomposability branch of the framework whole-part hierarchical relationships of the anatomical structures by decomposing each anatomical structure into its parts comprises:
receiving the medical image, I, as an input;
randomly sampling an anchor whole w from the input medical image;
decomposing the randomly sampled anchor whole w into a set of n non-overlapping parts P= {pᵢ}ⁿᵢ₌₁;
augmenting via the student network the set of n non-overlapping parts to generate whole embeddings z_{ws}=g_{θS}(T(w));
transmitting the whole embeddings to the decomposability branch head to produce a set of individual embeddings corresponding to constituent parts of the whole Zₚₛ=h_{θD}(z_{ws}); and
augmenting and processing by the teacher network the set of n non-overlapping parts P={pᵢ}ⁿᵢ₌₁ to generate parts' embeddings Zₚₜ={g_{θT}(T(pᵢ))}ⁿᵢ₌₁.

11. A system comprising:
a memory to store instructions;
a processor to execute the instructions stored in the memory;
a receive interface to receive a plurality of medical images obtained from a plurality of patients;
wherein the system is configured to perform self-supervised learning to learn visual representations of medical images of semantically similar anatomical structures of a plurality of patients, by executing the instructions via the processor for:
learning via a localizability branch of the framework a semantically structured embedding space by discriminating between different anatomical structures;
learning via a composability branch of the framework part-whole hierarchical relationships of the anatomical structures by constructing each anatomical structure through an integration of parts; and
learning via a decomposability branch of the framework whole-part hierarchical relationships of the anatomical structures by decomposing each anatomical structure into its parts.

12. The system of claim 11 wherein learning via the localizability branch of the framework the semantically structured embedding space by discriminating between different anatomical structures comprises clustering similar anatomical structures together and distinguishing the similar anatomical structures from dis-similar anatomical structures.

13. The system of claim 11, wherein learning via the localizability branch of the framework the semantically structured embedding space by discriminating between different anatomical structures comprises:
learning with a stochastic gradient descent parameters of a student network comprising a student encoder and a student head; and
learning, using an exponential moving average of weights for the student encoder and the student head, parameters of a teacher network comprising a teacher encoder and teacher head.

14. The system of claim 13, wherein learning via the localizability branch of the framework the semantically structured embedding space by discriminating between different anatomical structures comprises:
receiving a medical image, I, as an input;
randomly sampling an anchor patch w from the input medical image;
extracting a set C of multi-scale crops from the anchor patch w;
applying random data augmentations T to the anchor patch w and the multi-scale crops in the set C; and
generating the features yₜ=g_{θT}(T(w)) and Yₛ={g_{θS}(T(c))|c∈C}.

15. The system of claim 14, wherein learning via the composability branch of the framework part-whole hierarchical relationships of the anatomical structures by constructing each anatomical structure through an integration of parts comprises:
receiving the medical image, I, as an input;
randomly sampling an anchor whole w from the input medical image;
decomposing the randomly sampled anchor whole w into a set of n non-overlapping parts;
augmenting via the student network the set of n non-overlapping parts to generate parts' embeddings Yps={yi=g_{θS}(T(pᵢ))}ⁿᵢ₌₁;
concatenating and transmitting the parts' embeddings to a composability branch head to produce aggregated parts' embeddings zₚₛ=h_{θC}(⊕({yᵢ}ⁿᵢ₌₁)); and
augmenting and transmitting the whole anatomical structure w to the teacher network to generate the whole anatomical structure w's embeddings z_{wt}=g_{θT}(T(w)).

16. The system of claim 14, wherein learning via a decomposability branch of the framework whole-part hierarchical relationships of the anatomical structures by decomposing each anatomical structure into its parts comprises:
receiving the medical image, I, as an input;
randomly sampling an anchor whole w from the input medical image;
decomposing the randomly sampled anchor whole w into a set of n non-overlapping parts P={pᵢ}ⁿᵢ₌₁;
augmenting via the student network the set of n non-overlapping parts to generate whole embeddings z_{ws}=g_{θS}(T(w));
transmitting the whole embeddings to the decomposability branch head to produce a set of individual embeddings corresponding to constituent parts of the whole Zₚₛ=h_{θD}(z_{ws}); and
augmenting and processing by the teacher network the set of n non-overlapping parts P={pᵢ}ⁿᵢ₌₁ to generate parts' embeddings Zₚₜ={g_{θT}(T(pᵢ))}ⁿ₌₁.

17. A non-transitory computer-readable storage media having instructions stored thereupon that, when executed by a system having at least a processor and a memory therein, perform self-supervised learning to learn visual representations of medical images of semantically similar anatomical structures of a plurality of patients, by executing the instructions via the processor comprising:
learning via a localizability branch of the framework a semantically structured embedding space by discriminating between different anatomical structures;
learning via a composability branch of the framework part-whole hierarchical relationships of the anatomical structures by constructing each anatomical structure through an integration of parts; and
learning via a decomposability branch of the framework whole-part hierarchical relationships of the anatomical structures by decomposing each anatomical structure into its parts.

18. The non-transitory computer-readable storage media of claim 17, wherein learning via the localizability branch of the framework the semantically structured embedding space by discriminating between different anatomical structures comprises:
learning with a stochastic gradient descent parameters of a student network comprising a student encoder and a student head; and
learning, using an exponential moving average of weights for the student encoder and the student head, parameters of a teacher network comprising a teacher encoder and teacher head.

19. The non-transitory computer-readable storage media of claim 17, wherein learning via the localizability branch of the framework the semantically structured embedding space by discriminating between different anatomical structures comprises:
receiving a medical image, I, as an input;
randomly sampling an anchor patch w from the input medical image;
extracting a set C of multi-scale crops from the anchor patch w;
applying random data augmentations T to the anchor patch w and the multi-scale crops in the set C; and
generating the features yₜ=g_{θT}(T(w)) and Yₛ={g_{θS}(T(c))|c∈C}.

20. The non-transitory computer-readable storage media of claim 19, wherein learning via the composability branch of the framework part-whole hierarchical relationships of the anatomical structures by constructing each anatomical structure through an integration of parts comprises:
receiving the medical image, I, as an input;
randomly sampling an anchor whole w from the input medical image;
decomposing the randomly sampled anchor whole w into a set of n non-overlapping parts;
augmenting via the student network the set of n non-overlapping parts to generate parts' embeddings Yps={yi=g_{θS}(T(pᵢ))} “i=1;
concatenating and transmitting the parts' embeddings to a composability branch head to produce aggregated parts' embeddings zₚₛ=h_{θC}(⊕({yi}ⁿᵢ₌₁)); and
augmenting and transmitting the whole anatomical structure w to the teacher network to generate the whole anatomical structure w's embeddings z_{wt}=g_{θT}(T(w)).

21. The non-transitory computer-readable storage media of claim 19, wherein learning via a decomposability branch of the framework whole-part hierarchical relationships of the anatomical structures by decomposing each anatomical structure into its parts comprises:
receiving the medical image, I, as an input;
randomly sampling an anchor whole w from the input medical image;
decomposing the randomly sampled anchor whole w into a set of n non-overlapping parts P={pᵢ}ⁿᵢ₌₁;
augmenting via the student network the set of n non-overlapping parts to generate whole embeddings z_{ws}=g_{θS}(T(w));
transmitting the whole embeddings to the decomposability branch head to produce a set of individual embeddings corresponding to constituent parts of the whole Zₚₛ=h_{θD}(z_{ws}); and
augmenting and processing by the teacher network the set of n non-overlapping parts P={pᵢ)ⁿᵢ₌₁ to generate parts' embeddings Zₚₜ={g_{θT}(T(pᵢ))}ⁿᵢ₌₁.
